(19) United States
(12) Patent Application Publication
(10) Pub. No.: US 2005/0289038 A1
(43) Pub. Date: Dec. 29, 2005

(54) Method and system for voting for a future price of an asset

(75) Inventor: Alexander S. Karapetian, San Francisco, CA (US)

Correspondence Address: ALEXANDER KARAPETIAN, 1503 PERSHING DRIVE, APT D, SAN FRANCISCO, CA, 94129, US

(73) Assignee: Alexander S Karapetian, San Francisco, CA (US)

(21) Appl. No.: 10/710,236

(22) Filed: Jun. 28, 2004

(51) Int. Cl. G06F 17/60

(52) U.S. Cl. 705/37; 705/35

(57) ABSTRACT

A method and system for voting for a future price of an asset. The online system accepts preferences of a plurality of participants for what a price of an asset should be at a particular time point. Participants assign a number of votes to their preferences. The system computes and publishes a single measure of the preferences submitted by the participants, which depends on the values of the submitted preferences and the votes assigned to them.

### BACKGROUND OF INVENTION

1. Field of the Invention

The present invention relates to asset pricing methods, specifically to providing means of measurable influence of public preferences onto future asset prices.

2. Discussion of Prior Art

Asset pricing is affected by two sets of factors: objective and subjective. The objective factors are measures of micro and macroeconomic conditions and trends and represent the creative and adaptive forces of the market economy. The subjective factors represent the psychological component of the decision-making conducted by the market agents.

The importance of accounting for, and measurement of, the subjective factors continues to increase as more individuals act as asset market agents by means of online trading and auctioning. However, none of the known methods and systems provide a tool for actively influencing future asset prices.

Known methods and systems of gathering inputs of a plurality of participants related to future asset prices focus on the forecasting problem. The most widespread systems implementing those methods are called “forecasting contests”. In those systems participants compete for providing the best forecasting estimate of a future asset price. The quality of the forecast is determined at the future time point to which the forecast applies.

An example of such system is www.fantasystockmarket.com. The objective of the system is to identify the best predictors by rewarding the participants with the biggest portfolio. The system attracts participants by promising them an entertainment value. Another example of a forecasting contest is www.investorsforecast.com. It provides the participants with the opportunity to compete for the best prediction of stock market indices. The system rewards the best predictors with a fixed predetermined monetary amount. Yet another system, c4cast.com, aims at producing forecasts for financial and economic variables by conducting a contest among participants. The participants are ranked based on the accuracy of their predictions.

All of these methods and systems fail to provide an active asset pricing method. Their objective is identification of the best predictors. These methods lack the cause/effect mechanisms for actively inducing future asset prices. Instead, these systems focus on the passive role of the participants. The participants aim at providing their best estimates rather than expressing their preference for a future asset value. This creates “positive feedback” loops, which are known from the system theory to be unstable. Positive feedback loops in the asset markets reinforce any trend that may have its roots in psychologically erratic assumptions. An example of such a subjectively erratic assumption, which has grown into a major trend, is the “irrational exuberance” about the Internet-related securities in the late 1990's, or the periodic “real estate booms”, where the price of real estate is artificially inflated.

### BRIEF DESCRIPTION OF DRAWINGS

FIG. 1 shows a definition of the database interface for the preferred embodiments.

FIG. 2 illustrates an online input form for an unregistered participant.

FIG. 3 shows an ATL Server response file for an input form for an unregistered participant.

FIG. 4 shows an ATL Server handler for accepting an input from an unregistered participant.

FIG. 5 shows a C++ code for processing an input from an unregistered participant.

FIG. 6 illustrates an online input form for a registered partici pant.

FIG. 7 shows a C++ code for processing an input from a registered participant.

FIG. 8 illustrates an online form for purchasing additional votes and range extensions.

FIG. 9 shows a C++ code for checking an input from a registered participant against the allocated value ranges.

FIG. 10 shows an XML format schema for accepting a vote for a future value of an asset.

FIG. 11 shows a C++ code for processing a plurality of vote inputs.

FIG. 12 shows a Windows 2000/XP object code for calculating a CPV.

FIG. 13 shows signatures of function calls for calculating a CPV.

### DETAILED DESCRIPTION

The current invention provides a remedy to the known methods and systems of gathering and processing input related to future asset prices. The invention comprises a method and system that enable market agents to influence future asset prices, which reduces the probability of unexpected and psychologically motivated price disturbances on the actual trading days.

The invention utilizes the following terminology: (a) individual preference value (IPV). IPV is a value that a participant prefers for a particular asset to be priced at when a particular future time point arrives; (b) calculated preference value (CPV). CPV is calculated for a particular asset price for a particular future time point. The calculation procedure of CPV utilizes the accepted IPV's, as shown below.

The method of the invention comprises the following steps.

1. Accepting inputs from a number of participants, wherein any one of these inputs comprises an IPV of a particular participant.

2. Calculating the CPV and publishing it.

Accordingly, the preferred system embodiments of the present invention comprise inventive features which can be implemented individually or in a combination. Said features generally can be categorized as follows.

Participant Input Processing (PIP)

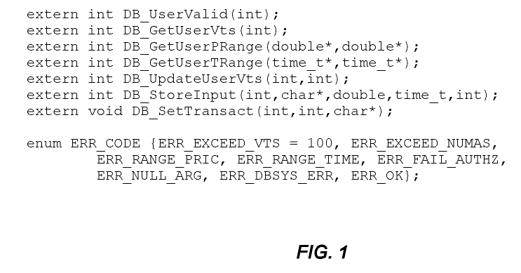

The preferred PIP embodiments comprise online entry forms, which participants use to submit their IPV's. Participants access these forms using web browsers by navigating to the online address at which the forms are located. In some embodiments participants submit additional data, as shown below. In the preferred embodiments the input is processed and sent to a database management system. A C++ file blm_input.h, containing the declaration of the database access function interface, is shown in FIG. 1.

PIP embodiment 1. In one PIP embodiment the participants are anonymous. Each participant is implicitly authorized to 1 vote.

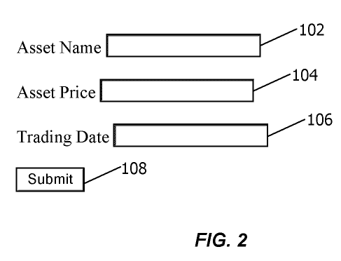

The input form for this embodiment is illustrated in FIG. 2. Input field 102 is for entering the asset name for which a participant is submitting an IPV. Input field 104 is for entering the IPV. Input field 106 is for entering the trading date for which the IPV is being submitted. To submit the input in fields 102 through 106 the participant presses button 108.

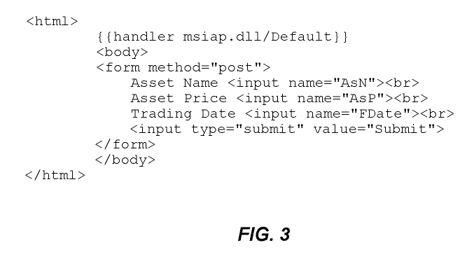

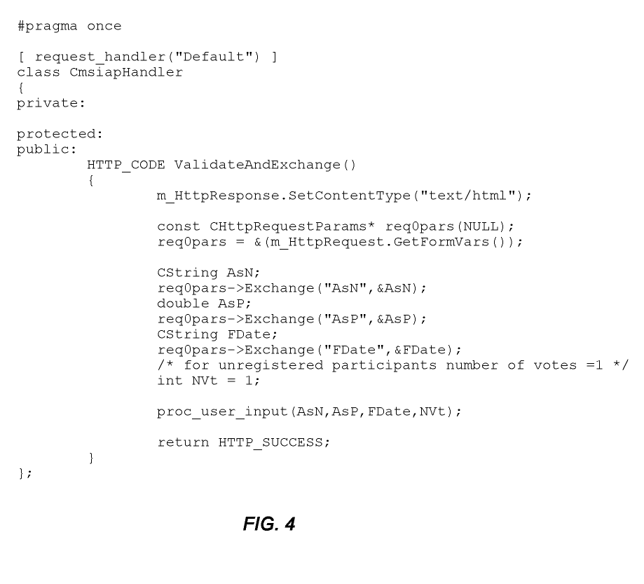

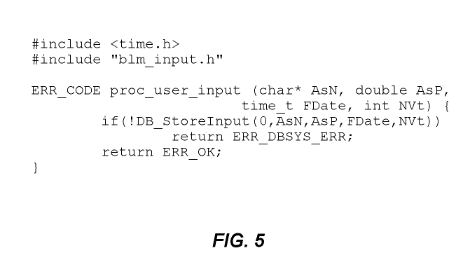

An implementation of input processing for this input form utilizes the C++ programming language and the ATL Server programming framework. An ATL Server Response File for this input form is shown in FIG. 3, and the corresponding processing handler code is shown in FIG. 4. A C++ implementation for sending this input to a database is shown in FIG. 5.

PIP embodiment 2. In another PIP embodiment participants have an option to register with the system free of charge. This embodiment may utilizes any third-party online software facility. One particular implementation of this embodiment utilizes the ATL Server Tutorial authentication and authorization facility.

A participant receives a unique user id upon registration. An unregistered participant has no user id, and is authorized to 1 vote. Each registered participant is authorized to the same, no less than 1, number of votes, which are assigned to this participant's user id. A registered participant can use these votes to vote for 1 or more IPV's.

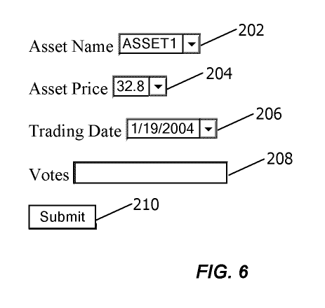

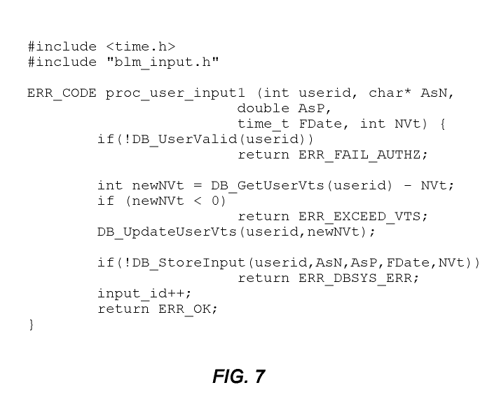

The input form for an unregistered participant is the same as in the PIP embodiment 1. The input form for a registered participant is illustrated in FIG. 6. Input field 202 is for entering the asset name for which the participant is submitting an IPV. Input field 204 is for entering the IPV. Input field 206 is for entering the trading date for which the IPV is being submitted. Input field 208 is for entering the number of votes that the participant assigns to the IPV being submitted. To submit the input in fields 202 through 208 the participant presses button 210. A C++ implementation for processing this input and sending it to a database is shown in FIG. 7.

PIP embodiment 3. In another PIP embodiment, registered participants can purchase a number of votes to use in their IPV submissions for a particular asset.

To prevent said participants from voting for an artificially depressed or escalated IPV, there is a range of values from which a participant can select an IPV. This range can be extended by purchasing. A participant can also purchase the time range from which at the moment of voting the participant can select the future time point for the IPV being submitted.

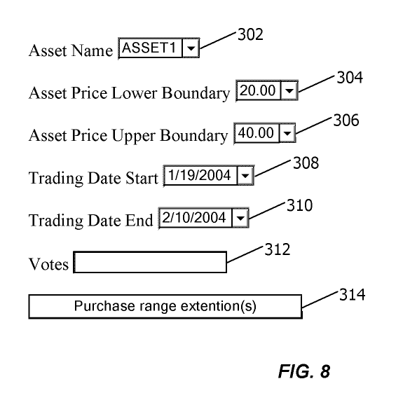

The purchase form for a registered participant is illustrated in FIG. 8. Input field 302 is for selecting the asset name for which the participant purchases votes or range extensions. Input fields 304 and 306 are for selecting the range of values from which the participant can select a particular IPV when voting. Input fields 308 and 310 are for selecting the time range when voting. Input field 312 is for entering a number of votes that the participant purchases for the asset indicated in field 302. To complete the purchase of values entered in fields 302 through 312 the participant presses button 314. After this the purchase information is stored in a database, and the participant is invited to make a payment.

The process of purchasing can be conducted repeatedly. At any particular time the number of votes purchased for a particular asset equals the sum of votes purchased during all of earlier vote purchases for that asset. The number of votes available for voting for a particular IPV is the sum of all purchased votes for the asset minus the sum of all votes previously used in submitting IPV's for the asset.

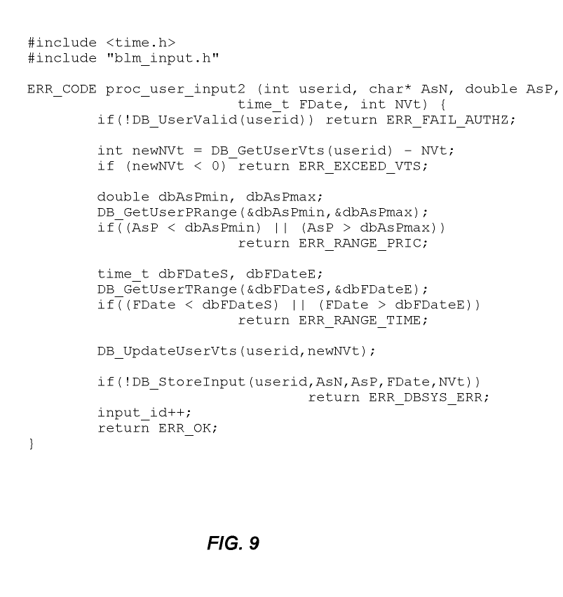

The input form for an unregistered participant is the same as in the PIP embodiment 1. The input form for a registered participant is the same as in the PIP embodiment 2. A C++ code for processing input in this PIP embodiment is shown in FIG. 9. The number of votes that a participant submits for a IPV is checked against the number of votes that the participant has purchased, said number being retrieved from the database. Range checks for IPV's and future time points are also done, as shown in FIG. 9.

PIP embodiment 4. Yet another PIP embodiment is equivalent to the embodiment 3 with the following difference. When used in combination with an online asset trading facility, the PIP in this embodiment grants a registered participant an additional number of votes in exchange for using said facility for online trading in asset markets.

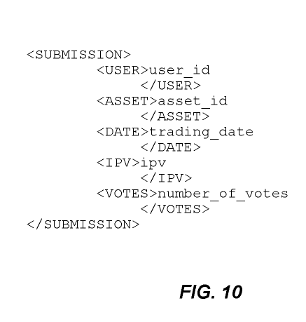

PIP embodiment 5 includes an automatic facility that a registered participant can utilize to vote on behalf of said participant. The automatic facility accepts an XML file which contains the participant's input. The XML input file can contain one or more submissions in the format illustrated in FIG. 10.

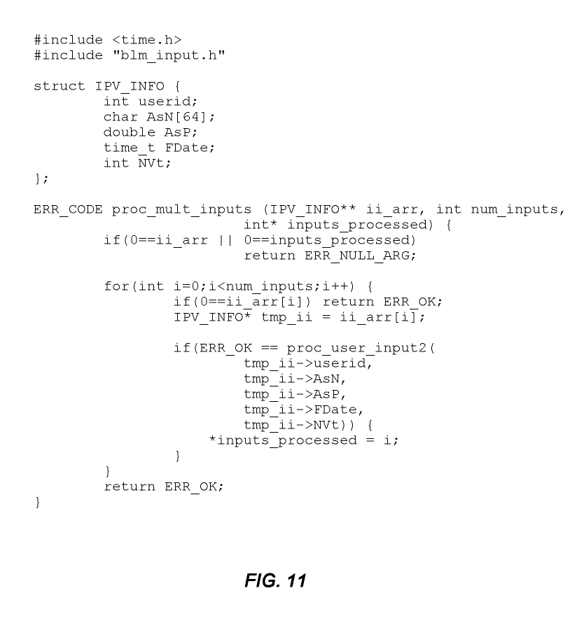

A C++ code for processing multiple submissions is shown in FIG. 11. Each submission from the file is read into an internal structure shown in lines 4 through 10 of the listing. The code traverses an array in a loop. Inside the loop each submission is passed to the processing routine shown in FIG. 9.

CPV Calculation (CPVC)

The object of CPVC is to produce a single measure for the preferences of a plurality of participants for what a price of an asset should be at a particular future time point. The input data for the CPVC comprises all IPV's and the votes associated with them. The input data is read from the database, where said data was previously stored by a PIP embodiment.

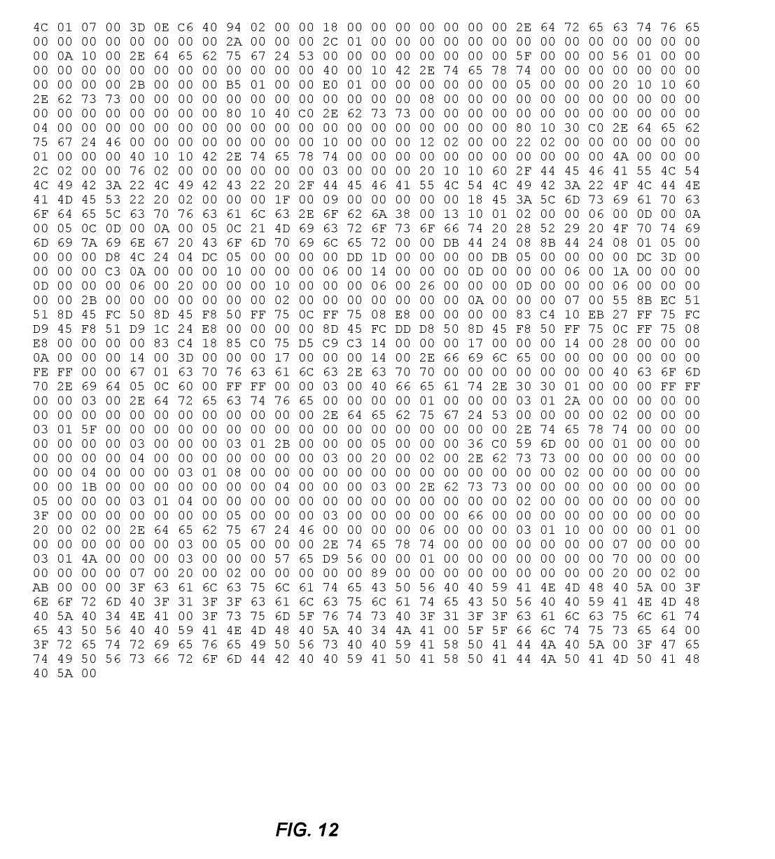

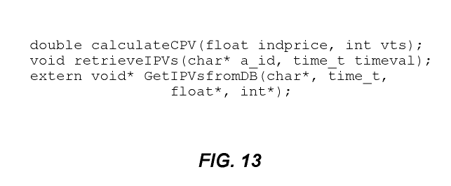

The preferred embodiment for CPVC is shown in FIG. 12. This embodiment is a C++ code in object file format for the Windows 2000/XP platform. The code in FIG. 12 is ready to be linked with a C++ program. There are two methods of invoking the code in FIG. 12. One of them is to call the function named calculateCPV for a particular asset and a particular future time point. The signature for calculateCPV shown in FIG. 13. This function has 2 arguments. Argument 1 is for the IPV and argument 2 is the number of votes associated with this IPV. This function can be called in a loop, and it returns the current CPV.

The other method is to call the function named retrieveIPVs. The signature for retrieveIPVs is shown in FIG. 13. Argument 1 is for the unique name of the asset for which the CPV is being calculated. Argument 2 is for the future time point for which the CPV is being calculated. This function will call the caller-provided database-specific function called GetIPVsfromDB, which should have the signature shown in FIG. 13.

The CPV is then published online and through mass media. In some embodiments, the IPV's and the votes used in the CPV calculation are sold to third parties.

1. A method for voting for a future price of an asset by a plurality of participants, said method comprising: (a) accepting a data submission from a participant, said data submission comprising a choice of said participant for the price of said asset at a particular future time point; (b) conducting a calculation of a numerical value for said asset for said future time point, wherein said calculation is a combination of the data submissions from said plurality of participants and means for mathematical aggregation of said data submissions into a single value; (c) publishing said single value no later than said future time point; whereby participants can influence the price at which said asset will trade when said future time point arrives.

2. The method of claim 1 further comprising publishing a subset of said data submissions from said plurality of participants.

3. The method of claim 1 wherein a data submission from a participant comprises a choice of said participant for the price of an asset at a future time point and a number of votes that said participant assigns to said choice.

4. The method of claim 3 wherein a participant purchases a number of votes that said participant can assign.

5. The method of claim 3 wherein a participant acquires a number of votes that said participant can assign by purchasing a pre-designated product.

6. The method of claim 3 wherein a participant acquires a number of votes that said participant can assign by purchasing a pre-designated service.
